(19) United States
(12) Patent Application Publication
(10) Pub. No.: US 2024/0358191 A1
(43) Pub. Date: Oct. 31, 2024

(54) GRILL FOR CLOSED LID BRAISING AND ROASTING

(71) Applicant: NINGBO AGSUN PRODUCTS,INC., CIXI (CN)

(72) Inventors: Jiong Yu, Cixi City (CN); Meng Lin, Hangzhou (CN); Jialong Yao, Shaoxing City (CN); Xuefei Mao, Cixi City (CN); Xianghua Liu, Huangshi City (CN)

(21) Appl. No.: 18/765,088

(22) Filed: Jul. 5, 2024

(30) Foreign Application Priority Data
Apr. 30, 2024 (CN) 202410539727.0

(51) Int. Cl. A47J 37/07; F23D 14/06; F23D 14/70; F24C 3/08

(52) U.S. Cl. CPC A47J 37/07; F23D 14/06; F23D 14/70; F24C 3/085

(57) ABSTRACT

The present invention discloses a grill for closed lid braising and roasting. The grill for closed lid braising and roasting adopts flames produced by burning of a burning portion for heating to generate a high-temperature gas flow, and the high-temperature gas flow enters a heat-gathering recess through a heat flow channel, and is uniformly diffused to a roasting net under an action of the heat-gathering recess and an extension portion to braise and roast food on the roasting net.

### TECHNICAL FIELD

The present invention pertains to the field of grills, and specifically relates to a grill for closed lid braising and roasting.

### BACKGROUND

A grill is a device which produces hot air to cook food by roasting, and is generally of a closed or semi-closed structure. Conventional grills use burning wood or charcoal for heating. Modern grills are multifunctional, and adopt electric heating or fuel gas respectively.

A gas grill is one of the mainstream grills in modern times: 1. For a spherical grill, refer to the spherical barbecue grill disclosed in Chinese Patent No. CN202020730341.5, which needs to adopt an annular burner to uniformly and fully cover an upper round roasting net. 2. For a square grill, refer to the gas barbecue grill with burner-bypassable temperature control disclosed in Chinese Patent No. CN202280016212.1, which needs to adopt a plurality of bar-shaped burners which extend back and forth and are arranged from the left to the right to uniformly and fully cover an upper square roasting net.

The conventional grills have the following defects:
1. The burners are large in size and high in cost.
2. Since food and residue can easily drop onto the burners, the burning efficiency and the uniformity of heating the roasting net can be affected when the food and residue are sintered and carbonized to block flame holes, and the smoke which is produced when the food is ignited to burn can affect physical health.
3. Since a large number of flame holes need to be arranged in the burners and it is difficult to evenly distribute the flame holes, the roasting net cannot be uniformly heated, and particularly, since the circumferential flame holes of the annular burners are not evenly distributed, the corresponding round roasting net cannot be uniformly and circumferentially heated.

### SUMMARY

In view of the defects in the prior art, the objective of the present invention is to provide a grill for closed lid braising and roasting, which adopts flames produced by burning of a burning portion for heating to generate a high-temperature gas flow, and the high-temperature gas flow enters a heat-gathering recess through a heat flow channel, and is uniformly diffused to a roasting net under an action of the heat-gathering recess and an extension portion to braise and roast food on the roasting net.

In order to achieve the above objective, the present invention provides the following technical solution: A grill for closed lid braising and roasting includes: a grill body, where a grill chamber is arranged in the grill body; a roasting net, where the roasting net is arranged in the grill chamber to divide the grill chamber into a braising and roasting chamber and a burning chamber, a burning portion is arranged in the burning chamber, the roasting net is provided with a net-like roasting area and a heat flow channel running through from top to bottom, and the heat flow channel is arranged opposite to the burning portion; and a flow guide, where the flow guide is arranged in the braising and roasting chamber, and includes a heat-gathering portion and an extension portion, the extension portion surrounds a periphery of the heat-gathering portion, the heat-gathering portion is provided with a sunken heat-gathering recess, a spacing exists between the roasting net and the flow guide, the heat flow channel is arranged opposite to the heat-gathering recess, and the extension portion is arranged opposite to the roasting area. A high-temperature gas flow generated by burning of the burning portion passes through the heat flow channel and reaches the heat-gathering recess, the heat-gathering recess guides the high-temperature gas flow to the extension portion and the roasting area, and the extension portion also guides the high-temperature gas flow to the roasting area.

Further, the burning portion includes a flame outlet, where an inner diameter of the flame outlet is s1, and an inner diameter of the heat flow channel is s2; and a low end of the heat-gathering recess is provided with a heat-gathering opening, and an inner diameter of which is s3, where s1<s2<s3.

Further, the heat-gathering portion includes a top plate and a ring-shaped first flow guide skirt, where an upper end of the first flow guide skirt is connected to an edge of the top plate; the first flow guide skirt is gradually enlarged from top to bottom, so that the first flow guide skirt is inclined relative to the top plate, and an included angle between the first flow guide skirt and the top plate is α, which is an obtuse angle.

Further, the extension portion includes a horizontal flow guide portion and a ring-shaped second flow guide skirt, where the second flow guide skirt is continuously arranged along an edge of the horizontal flow guide portion; the second flow guide skirt is gradually enlarged from top to bottom, so that the second flow guide skirt is inclined relative to the horizontal flow guide portion; and an included angle between the second flow guide skirt and the horizontal flow guide portion is β, which an obtuse angle.

Further, an upper wall of the flow guide is spaced from an inner circumferential wall of the braising and roasting chamber, to form a heat preservation chamber between an upper sidewall formed by jointing an upper side of the heat-gathering portion and an upper side of the extension portion and the inner circumferential wall of the braising and roasting chamber; and a communicating chamber is arranged between a periphery of the second flow guide skirt and the inner circumferential wall of the braising and roasting chamber, and is configured to communicate the heat preservation chamber with the braising and roasting chamber.

Further, a periphery of the extension portion is provided with a plurality of abutting portions in a circumferential direction, where each of the abutting portions abuts against the inner circumferential wall of the braising and roasting chamber; each of the abutting portions includes a first connecting portion arranged on the horizontal flow guide portion and two second connecting portions arranged on the second flow guide skirt, where the second connecting portions are located at both sides of the first connecting portion respectively; the second flow guide skirt is provided with communicating holes respectively at positions corresponding to the abutting portions, where each of the communicating holes is located between the two second connecting portions of each of the abutting portions respectively, and a space enclosed by an inner circumferential side of the second flow guide skirt communicates with the communicating chamber.

Further, the burning portion includes a burner and a flame-gathering cover, where the flame-gathering cover is sleeved on a burning area of the burner, the burner is arranged in a volute shape, the burning area of the burner is annularly arranged along a spiral path of the burner, and a plurality of burning ports which communicate with an internal cavity of the burner to jet flames are arranged in the burning area of the burner; the plurality of burning ports are arranged in an annular array along the burning area of the burner, and all located in an inner circumference of the flame-gathering cover; the flame-gathering cover is gradually reduced from top to bottom, so that an inner diameter of an upper port of the flame-gathering cover is less than that of a lower port; and therefore, flames jetted out of the burning ports can be converged and then jetted out of the upper port of the flame-gathering cover, and a flame on the inner circumference of the flame-gathering cover and a flame at the upper port of the flame-gathering cover can burn the flame-gathering cover red.

Further, a bottom of the burning chamber is provided with an installation port, an annular cover is arranged in the burning chamber, and is continuously arranged along an edge of the installation port, and the annular cover is gradually reduced from bottom to top, so that an inner diameter of an upper port of the annular cover is less than that of a lower port; at least a part of the flame-gathering cover and at least a part of the burning area of the burner are both located in the annular cover, and after running through the upper port of the annular cover, the upper end of the flame-gathering cover extends out or is located in the annular cover; and a plurality of air supply openings are arranged in a circumferential wall of the flame-gathering cover, so that the inside of the flame-gathering cover communicates with the outside, and at least a part of the air supply openings are located in the annular cover.

Further, a flow channel head end of the internal cavity of the burner and a flow channel tail end of the internal cavity of the burner are cut off; a flow guide channel is arranged between each of the burning ports and the internal cavity of the burner, and is inclined upwards and inwards along a volute extending direction of the internal cavity of the burner; a cross-sectional shape of the internal cavity of the burner from the flow channel head end of the internal cavity of the burner to a flow channel tail end of the internal cavity of the burner is gradually reduced; an included angle between an axis in an extending direction of each of the flow guide channels and a volute axis of the internal cavity of the burner is γ, which is an acute angle; a shape of the flow guide channel is gradually reduced from an end close to the internal cavity of the burner to an end far from the internal cavity of the burner; the cross-sectional shape of the internal cavity of the burner is gradually reduced from a lower end to an upper end thereof; the inner circumference of the burner is provided with an avoidance cavity, and the burning ports are formed by being arranged along an edge of an upper port of the avoidance cavity; the burner is provided with a gradually reduced upward protective section located over the burning ports, where an upper end of the protective section circumferentially encloses a first flame port; the internal cavity of the burner is provided with an inner flow channel wall and an outer flow channel wall, where the inner flow channel wall is annularly arranged, the outer flow channel wall is located on a periphery of the inner flow channel wall, the outer flow channel wall gradually approaches the inner flow channel wall from the flow channel head end to the flow channel tail end, and the flow guide channels are arranged over the inner flow channel wall at intervals in a circumferential direction of the inner flow channel wall; the internal cavity of the burner is provided with an upper flow channel wall and a flow-increasing sidewall, where the upper flow channel wall is inclined upwards from a side of the outer flow channel wall to a side of the inner flow channel wall, the flow-increasing sidewall is arranged at an end of the flow channel tail end, is located between the upper flow channel wall and the outer flow channel wall, and is arranged in an outwardly arched arc shape.

Further, the grill body includes a grill base and a grill lid, where a connecting portion of the grill lid is rotatably connected to an opening edge of the grill base, the grill lid is turned to open or close the grill chamber, and the flow guide is arranged on the grill lid.

By adopting the above technical solution, the present invention has the following advantages:
1. Food to be roasted is placed in the roasting area, the burning portion then burns in the burning chamber to generate flames, the flames heat the air to form a high-temperature gas flow, and the high-temperature gas flow flows upwards to enter the braising and roasting chamber through the heat flow channel, and then continues to flow upwards into the heat-gathering recess; under the action of a circumferential wall of the heat-gathering recess, the high-temperature gas flow is circumferentially diffused along the circumferential wall of the heat-gathering recess; after the high-temperature gas flow leaves the heat-gathering recess, a part of the high-temperature gas flow directly flows downwards to the roasting area under the action of inertia to roast the food in the roasting area, while another part of the high-temperature gas flow flows to the circumferential wall of the braising and roasting chamber along the extension portion and flows downwards along the circumferential wall of the braising and roasting chamber to supply heat to the edge of the roasting area, coupled with another part of the high-temperature gas flow located between the above two parts of the high-temperature gas flow, and ultimately, the high-temperature gas flow more fully covers the roasting area, so that the food in the roasting area is more uniformly heated and roasted; in addition, the high-temperature gas flow can also enter the lower burning chamber through the net-like roasting area, so that the air in the burning chamber is heated to better roast the food from the bottom of the food, and therefore, the food is more uniformly roasted.
2. The burning portion only needs to burn to heat a position corresponding to the heat flow channel, so that the burning portion does not need to cover the roasting area evenly, and therefore, the burning portion is smaller in overall size and lower in cost; moreover, because the roasting area and the burning portion are vertically staggered, the food and residue in the roasting area will not drop onto the burning portion, and therefore, the food and residue are prevented from being sintered and carbonized to block flame holes, and will not be directly ignited by the flames to produce smoke to affect physical health.

### BRIEF DESCRIPTION OF THE DRAWINGS

FIG. 1 is an assembly diagram in Embodiment 1 of the present invention;

FIG. 2 is an assembly diagram of a part of the structure in Embodiment 1 of the present invention;

FIG. 3 is an exploded diagram of a part of the structure in Embodiment 1 of the present invention;

FIG. 4 is a sectional view of a part of the structure in Embodiment 1 of the present invention;

FIG. 5 is a sectional view of a part of the structure in Embodiment 1 of the present invention;

FIG. 6 is a part diagram of a roasting net part in Embodiment 1 of the present invention;

FIG. 7 is a part diagram of a flow guide in Embodiment 1 of the present invention;

FIG. 8 is an exploded view of a grill lid in Embodiment 1 of the present invention;

FIG. 9 is an exploded view of a burning portion in Embodiment 1 of the present invention;

FIG. 10 is a partial schematic structural diagram of the burning portion in Embodiment 1 of the present invention;

FIG. 11 is a sectional view of a burner in Embodiment 1 of the present invention;

FIG. 12 is an enlarged view of A in FIG. 11;

FIG. 13 is an enlarged view of B in FIG. 11;

FIG. 14 is a partial schematic structural diagram of the burner in Embodiment 1 of the present invention;

FIG. 15 is an exploded view of part of the structure in Embodiment 1 of the present invention;

FIG. 16 is an exploded view of part of the structure in Embodiment 3 of the present invention;

FIG. 17 is an enlarged view of C in FIG. 16; and

FIG. 18 is an assembly diagram of a collector in Embodiment 3 of the present invention.

### REFERENCE NUMERALS

1. grill body;
11. grill chamber; 12. grill base; 13. grill lid; 14. cart body;
141. gas tank; 142. roller;
111. braising and roasting chamber; 112. burning chamber; 113. installation port;
122. fixed plate; 123. roasting basin;
1231. water basin; 1232. outer wall; 1233. bottom wall; 1234. annular cover;
131. air outlet; 132. rotating part; 133. communicating port; 134. turning handle; 135. temperature gauge; 136. sensing end;
2. roasting net
21. roasting area; 22. heat flow channel; 23. partition ring;
3. burning portion
31. burner; 32. flame-gathering cover; 33. flow channel head end; 34. flow channel tail end;
311. burning port; 312. flow guide channel; 313. avoidance cavity; 314. protective section; 315. first flame port; 316. inner flow channel wall; 317. outer flow channel wall; 318. upper flow channel wall; 319. flow-increasing sidewall; 321. flame outlet; 322. air supply opening;
4. flow guide;
41. heat-gathering portion; 42. extension portion; 43. heat preservation chamber; 44. communicating chamber;
411. heat-gathering recess; 412. top plate; 413. first flow guide skirt; 421. horizontal flow guide portion; 422. second flow guide skirt; 423. abutting portion;
4111. heat-gathering opening; 4231. first connecting portion; 4232. second connecting portion; 4233. communicating hole;
6. mounting frame;
61. retaining ring; 62. support rod; 63. access notch; 64. retaining notch;
621. mounting section; 622. lower side section; 623. support section;
7. collector;
71. vessel portion; 72. handle portion; 73. assembling rod; 74. connecting rod.

### DESCRIPTION OF THE EMBODIMENTS

### Embodiment 1

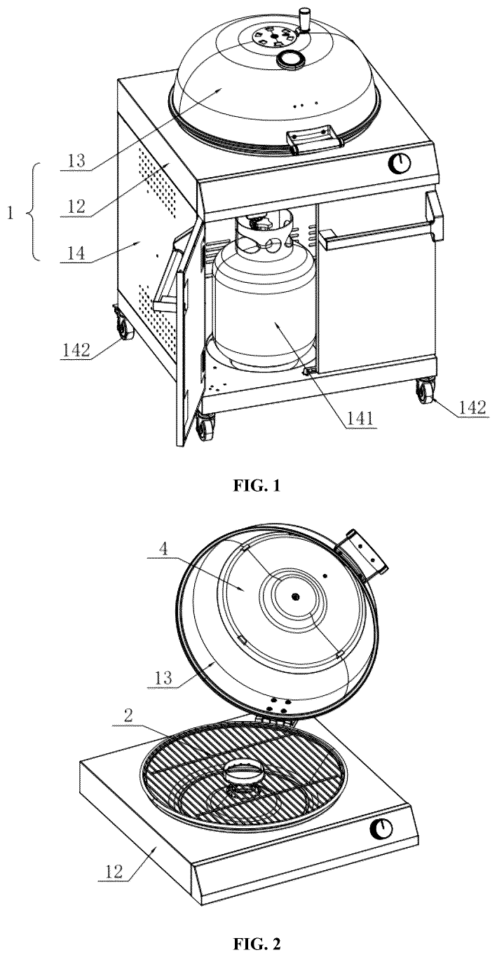

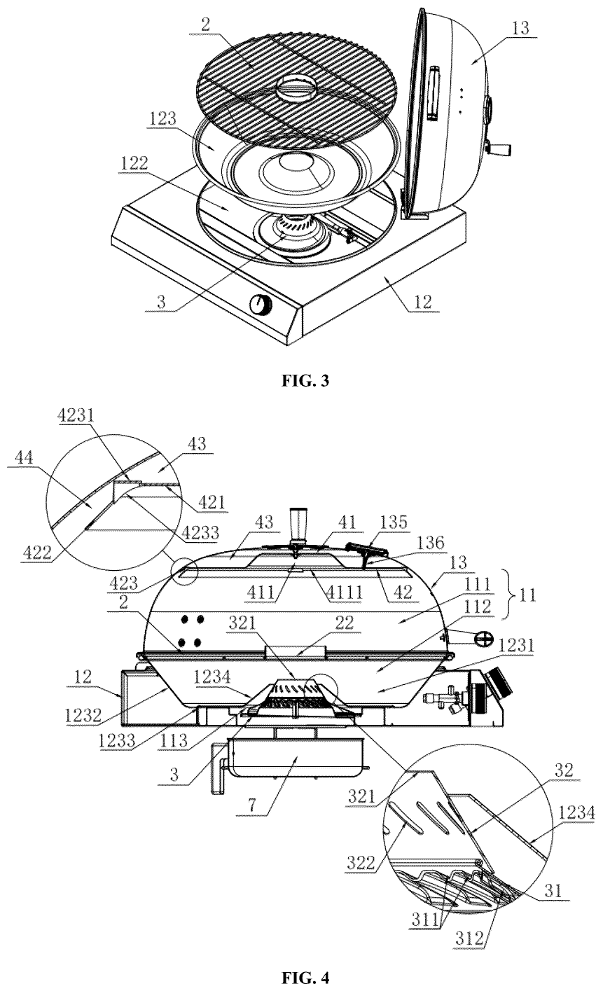

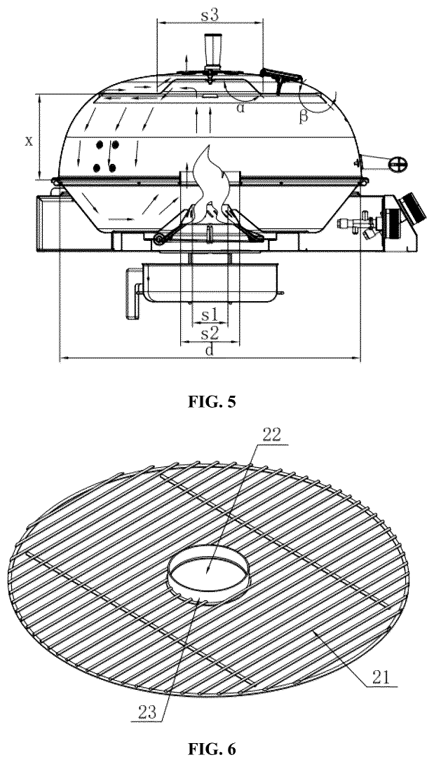

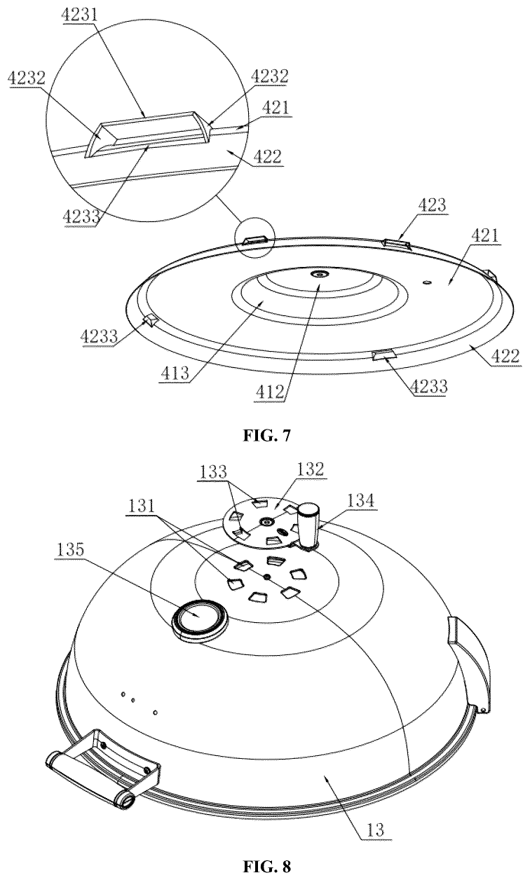

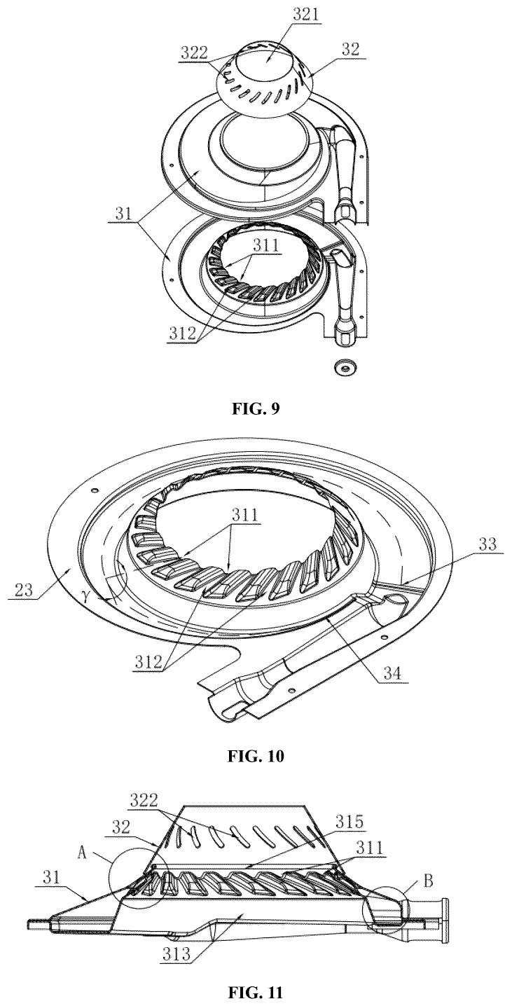

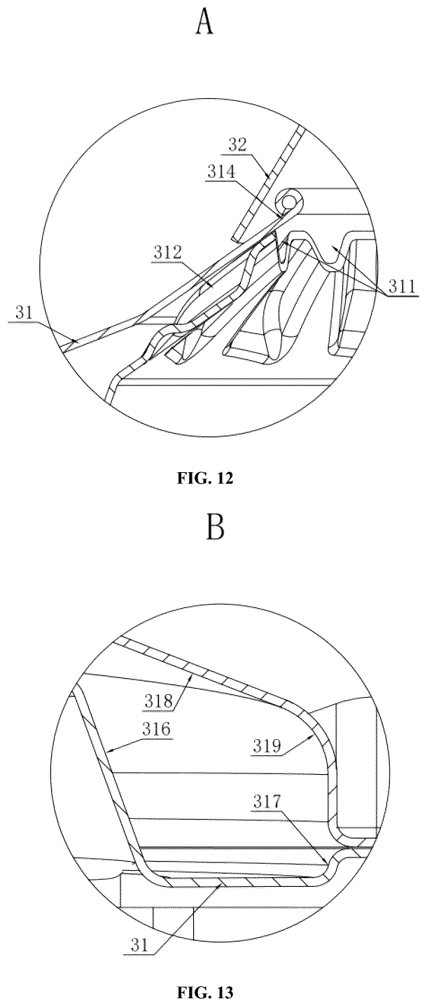

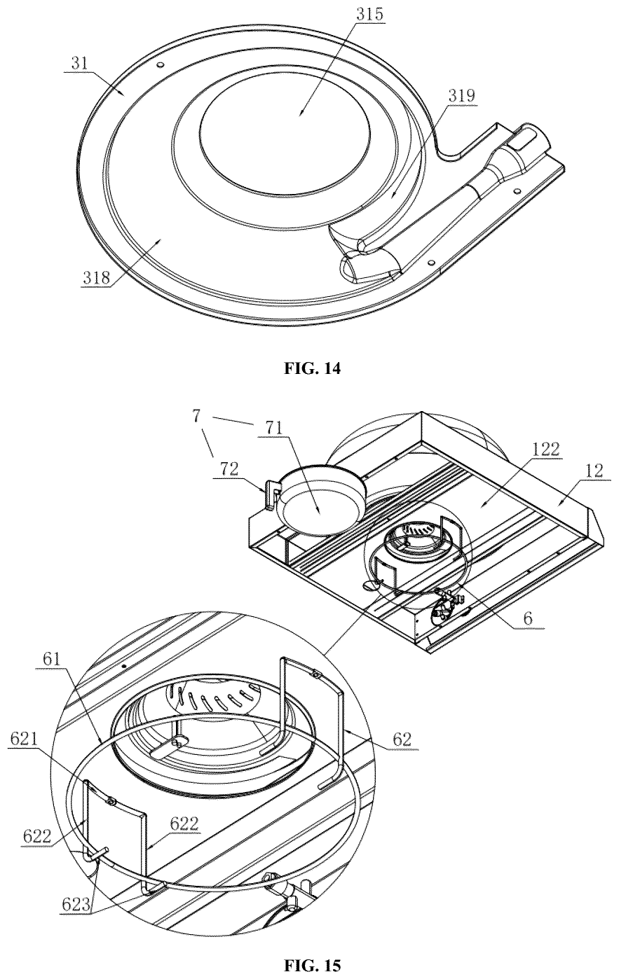

As shown in FIGS. 1 to 15, the present invention discloses a grill for closed lid braising and roasting, including:
a grill body 1, where a grill chamber 11 is arranged in the grill body 1;
a roasting net 2, where the roasting net 2 is arranged in the grill chamber 11 to divide the grill chamber 11 into a braising and roasting chamber 111 located on the upper side of the roasting net 2 and a burning chamber 112 located on the lower side of the roasting net 2, the roasting net 2 is provided with a net-like roasting area 21 and a heat flow channel 22 running through from top to bottom, and the roasting area 21 surrounds a periphery of the heat flow channel 22;
a burning portion 3, where the burning portion 3 is arranged in the burning chamber 112, and the heat flow channel 22 is arranged opposite to the burning portion 3; and
a flow guide 4, where the flow guide 4 is arranged in the braising and roasting chamber 111, and includes a heat-gathering portion 41 and an extension portion 42, the extension portion 42 surrounds a periphery of the heat-gathering portion 41, the heat-gathering portion 41 is provided with an upwardly sunken heat-gathering recess 411, a spacing exists between the roasting net 2 and the flow guide 4, the heat flow channel 22 is arranged opposite to the heat-gathering recess 411, and the extension portion 42 is arranged opposite to the roasting area 21.

During operation, a high-temperature gas flow generated by the burning of the burning portion 3 upwardly passes through the heat flow channel 22 and then reaches the heat-gathering recess 411, the heat-gathering recess 411 guides the high-temperature gas flow to the extension portion 42 and the roasting area 21, and the extension portion 42 also guides the high-temperature gas flow to the roasting area 21.

By adopting the above structure, the present invention has the following advantages:

Firstly, food to be roasted is placed in the roasting area 21, the burning portion 3 then burns in the burning chamber 112 to generate flames, the flames heat the air to form a high-temperature gas flow, and the high-temperature gas flow flows upwards to enter the braising and roasting chamber 111 through the heat flow channel 22, and then continues to flow upwards into the heat-gathering recess 411; under the action of a circumferential wall of the heat-gathering recess 411, the high-temperature gas flow is circumferentially diffused along the circumferential wall of the heat-gathering recess 411; after the high-temperature gas flow leaves the heat-gathering recess 411, a part of the high-temperature gas flow directly flows downwards to the roasting area 21 under the action of inertia to roast the food in the roasting area 21, while another part of the high-temperature gas flow flows to a circumferential wall of the braising and roasting chamber 111 along the extension portion 42 and flows downwards along the circumferential wall of the braising and roasting chamber 111 to supply heat to the edge of the roasting area 21, coupled with another part of the high-temperature gas flow located between the above two parts of the high-temperature gas flow, and ultimately, the higher-temperature gas flow more fully covers the roasting area 21, so that the food in the roasting area 21 is more uniformly heated and roasted; in addition, the high-temperature gas flow can also enter the lower burning chamber 112 through the net-like roasting area 21, so that the air in the burning chamber 112 is heated to better roast the food from the bottom of the food, and therefore, the food is more uniformly roasted.

Secondly, the burning portion 3 only needs to burn to heat a position corresponding to the heat flow channel 22, so that the burning portion 3 does not need to cover the roasting area 21 evenly, and therefore, the burning portion 3 is smaller in overall size and lower in cost; moreover, the roasting area 21 and the burning portion 3 are vertically staggered, so that the food and residue in the roasting area 21 will not drop onto the burning portion 3, and therefore, the food and residue are prevented from being sintered and carbonized to block flame holes, and will not be directly ignited by the flames to produce smoke to affect physical health.

Specifically, the grill body 1 in this embodiment includes a grill base 12 and a grill lid 13 covering the grill base 12. The grill lid 13 uses hinges as connecting portions, so that the grill lid 13 is rotatably mounted at the opening edge of the grill base 12 through the connecting portions. Therefore, the grill lid 13 covers the grill base 12 to form the grill chamber 11, the burning chamber 112 is located in the grill base 12, and the braising and roasting chamber 111 is located in the grill lid 13. In addition, the grill lid 13 is turned to open the grill chamber 11, and the flow guide 4 is arranged on the grill lid 13.

By adopting the above structure, the present invention has the following advantages: When the grill lid 13 is opened after braising and roasting is accomplished, because the high-temperature gas flow generated by the burning of the burning portion 3 only flows upwards in an area in which the heat flow channel 22 is located and is directly jetted into the air to lose heat, the supply of heat source stops around the food, and the part of the burning chamber 112 corresponding to the roasting area 21 quickly dissipates heat, so that the food can be more safely taken out or placed and a user can be prevented from being scalded by the high-temperature gas flow when taking out or placing food under the condition that the burning portion 3 is not closed.

In other embodiments, the grill lid 13 and the grill base 12 are separately arranged.

Preferably, the roasting net 2 in this embodiment is provided with an upwardly extending partition ring 23 located on the periphery of the heat flow channel 22. Therefore, the partition ring 23 is arranged to physically partition the roasting area 21 from the heat flow channel 22 directly, so that not only the food in the roasting area 21 is prevented from entering the heat flow channel 22 and being directly burnt by the flames, but also both the flames and the high-temperature gas flow are guided upwards under the action of the partition ring 23 to be better converged towards the heat-gathering recess 411.

In this embodiment, the heat flow channel 22 is shaped like a round hole. In other embodiments, the heat flow channel 22 may be polygonal.

Preferably, the upper end of the burning portion 3 in this embodiment is provided with a round flame outlet 321, the inner diameter of which is s1; the inner diameter of the heat flow channel 22 and the inner circumferential diameter of the partition ring 23 are the same, both of which are s2; the lower end of the heat-gathering recess 411 is provided with a round heat-gathering opening 4111, the inner diameter of which is s3, where s1<s2<s3.

Therefore, the flame outlet 321, the heat flow channel 22 and the heat-gathering opening 4111 are enlarged in sequence, to more fully cover the high-temperature gas flow which is rising and being gradually diffused outwards for reducing or eliminating the flames from the flame outlet 321 to the heat flow channel 22, and further avoid a case in which the roasting area 21 is nonuniform in heating as the high-temperature gas flow acts on the roasting area 21; moreover, the flame from the heat flow channel 22 to the heat-gathering recess 411 can be reduced or eliminated, and excessive high-temperature gas flow is prevented from flowing to the edge of the roasting net 2 due to the diffusion of the high-temperature gas flow to the extension portion 42 to make the temperature of the roasting area 21 nonuniform (where the heat at the edge of the roasting net 2 can be easily diffused to the outside from the gap between the grill base 12 and the grill lid 13), so that less heat is guided to this position, reducing energy loss.

Specifically, the heat-gathering portion 41 in this embodiment includes a top plate 412 and a ring-shaped first flow guide skirt 413, and the upper end of the first flow guide skirt 413 is connected to the edge of the top plate 412. Preferably, the first flow guide skirt 413 is gradually enlarged from top to bottom, so that the first flow guide skirt 413 is inclined relative to the top plate 412, and an included angle between the first flow guide skirt 413 and the top plate 412 is α, which is an obtuse angle (more preferably, 120°≤α≤150°, and α=135° in this embodiment).

Therefore, the high-temperature gas flow rising from the heat flow channel 22 is jetted onto the top plate 412 and outwardly diffused to the first flow guide skirt 413 in a radial direction of the top plate 412, and then obliquely flows downwards along the first flow guide skirt 413 with a certain angle of inclination, so that the high-temperature gas flow which subsequently leaves the heat-gathering recess 411 flows to the roasting area 21 more quickly under the action of inertia to roast the food in the roasting area 21. Moreover, the inclined first flow guide skirt 413 can more smoothly guide the gas flow at the intersection with the top plate 412, preventing the first flow guide skirt 413 from shifting excessively to collide with surroundings to produce abnormal sound as high-temperature gas perpendicularly impacts the first flow guide skirt 413 due to an included angle close to 90° between the first flow guide skirt 413 and the top plate 412, or preventing the temperature of the roasting area 21 from being nonuniform and excessive heat from being diffused to the outside from the gap between the grill lid 13 and the grill base 12 as more high-temperature gas flow is guided to the edge of the roasting net 2 due to an included angle close to 180° between the first flow guide skirt 413 and the top plate 412.

Specifically, the extension portion 42 in this embodiment includes a horizontal flow guide portion 421 and a ring-shaped second flow guide skirt 422. The lower edge of the first flow guide skirt 413 is connected to the horizontal flow guide portion 421, and the second flow guide skirt 422 is continuously arranged along the edge of the horizontal flow guide portion 421. The second flow guide skirt 422 is gradually enlarged from top to bottom, so that the second flow guide skirt 422 is inclined relative to the horizontal flow guide portion 421, and an included angle between the second flow guide skirt 422 and the horizontal flow guide portion 421 is β, which is an obtuse angle (preferably, 120°≤β≤150°, and β=135° in this embodiment).

Therefore, the high-temperature gas flow guided from the heat-gathering portion 41 can be more smoothly diffused outwards under the action of the horizontal flow guide portion 421, and the high-temperature gas flow can be more smoothly guided and transferred to the inner circumferential wall of the braising and roasting chamber 111 under the action of the second flow guide skirt 422 and then guided downwards.

Preferably, in this embodiment, an upper wall of the flow guide 4 is spaced from the inner circumferential wall of the braising and roasting chamber 111, so that a heat preservation chamber 43 is formed between an upper sidewall formed by jointing the upper side of the heat-gathering portion 41 and the upper side of the extension portion 42 and the inner circumferential wall of the braising and roasting chamber 111; and in addition, a communicating chamber 44 is arranged between a periphery of the second flow guide skirt 422 and the inner circumferential wall of the braising and roasting chamber 111, and is configured to communicate the heat preservation chamber 43 with the braising and roasting chamber 111 under the flow guide 4.

Therefore, with the arrangement of the communicating chamber 44, heat can be more quickly transferred into the heat preservation chamber 43 over the flow guide 4 from under the flow guide 4, so that the temperature of the heat preservation chamber 43 is closer to that under the flow guide 4. Therefore, the high-temperature gas flow flowing on the surface of the flow guide 4 upwardly transfers less heat into the heat preservation chamber 43 via the flow guide 4, so that the energy loss of the high-temperature gas flow flowing under the flow guide 4 is less, and therefore, the high-temperature gas flow can flow towards the roasting area 21 at a higher temperature, enhancing the effect of roasting food in the roasting area 21.

In addition, a periphery of the extension portion 42 is provided with a plurality of abutting portions 423 in a circumferential direction, where each abutting portion 423 abuts against the inner circumferential wall of the braising and roasting chamber 111. In this way, the abutting portions 423 abut against the inner circumferential wall of the braising and roasting chamber 111, so that the stability of connection of the flow guide 4 and the grill lid 13 is better, to reduce the sound generated by collision between the flow guide 4 and the grill lid 13 due to the impact of the high-temperature gas flow.

In addition, each abutting portion 423 includes a first connecting portion 4231 arranged on the horizontal flow guide portion 421 and two second connecting portions 4232 arranged on the second flow guide skirt 422, and the second connecting portions 4232 are located at both sides of the first connecting portion 4231 respectively, to improve the bending resistance of the first connecting portion 4231, and further improve the abutting stability of the flow guide 4 and the grill lid 13.

In addition, the second flow guide skirt 422 is provided with communicating holes 4233 respectively at the positions corresponding to the abutting portions 423, where each of the communicating holes 4233 is located between the two second connecting portions 4232 of the abutting portion 423, and the space enclosed by the inner circumferential side of the second flow guide skirt 422 communicates with the communicating chamber 44. Therefore, under the action of the communicating holes 4233, a part of the high-temperature gas flow can enter the communicating chamber 44 through the communicating holes 4233, and ultimately, a part of the high-temperature gas flow can upwardly enter the heat preservation chamber 43 to ensure the temperature of the heat preservation chamber 43.

In addition, the top of the grill lid 13 is provided with a plurality of air outlets 131 in a circumferential direction, and correspondingly, the top of the grill lid 13 is hinged with a rotating part 132, which is provided with a plurality of communicating ports 133 in a circumferential direction, so that the air outlets 131 can communicate with the communicating ports 133 by rotation to exhaust the hot gas inside and can control the exhaust speed by controlling an overlapping area between the air outlets 131 and the communicating ports 133. It should be noted that it is necessary to communicate the air outlets 131 with the communicating ports 133 in the process of braising and roasting, so that the outside air with higher oxygen content can be brought into the grill chamber 11 from the lower end under the action of a pressure difference generated by the burning of the burner 31, a part of the hot gas generated by burning in the grill chamber 11 can be dispersed onto the roasting net by the flow guide and the redundant hot gas can be guided along the inner walls of the flow guide 4 and the grill lid 13 under the action of gas pressure and ultimately exhausted from the air outlets 131, realizing the flow of the air in the grill chamber 11 to ensure the full burning of fuel gas in the grill chamber 11. It should be noted that the hot gas generated by burning in the grill chamber 11 is composed of a product of air-fuel gas burning and some incompletely burnt gas.

A turning handle 134 is arranged on the rotating part 132 to control the rotation of the rotating part 132.

In addition, a temperature gauge 135 is mounted on the grill lid 13 and located over the flow guide 4. In addition, a sensing end 136 of the temperature gauge 135 passes through the flow guide 4 from the upper end of the flow guide 4 to get under the flow guide 4 to detect the temperature below the flow guide 4.

In addition, the burning portion 3 includes a burner 31 and a flame-gathering cover 32. The flame-gathering cover 32 is sleeved on a burning area of the burner 31, and the burner 31 is arranged in a volute shape, with the upper end of the burner 31 serving as the burning area. The burning area of the burner 31 is annularly arranged along a spiral path of the burner 31, and a plurality of burning ports 311 which communicate with an internal cavity of the burner 31 for flame jetting are arranged in the burning area of the burner 31. The internal cavity of the burner 31 is arranged in a volute shape adapting to the shape of the burner 31, and a flow channel head end 33 and a flow channel tail end 34 of the internal cavity of the burner 31 are cut off, so that gas flow can stop at the flow channel tail end 34 after entering the internal cavity of the burner 31 through the flow channel head end 33, that is, the gas flow at the flow channel tail end 34 will not flow to the flow channel head end 33 without passing through the internal cavity of the burner 31. The plurality of burning ports 311 are arranged in an annular array along the burning area of the burner 31 and are all located on the inner circumference of the flame-gathering cover 32, the flame-gathering cover 32 is gradually reduced from bottom to top, so that the inner diameter of an upper port of the flame-gathering cover 32 is less than that of a lower port, and the flame outlet 321 is located at the upper end of the flame-gathering cover 32. Therefore, flames jetted out of the burning ports 311 can be converged and then jetted out of the flame outlet 321 at the upper end of the flame-gathering cover 32, and the flame on the inner circumference of the flame-gathering cover 32 and the flame at the upper port of the flame-gathering cover 32 can burn the flame-gathering cover 32 red. In addition, a flow guide channel 312 is arranged between each burning port 311 and the internal cavity of the burner 31, and the flow guide channels 312 are inclined upwards and inwards along a volute extending direction of the internal cavity of the burner 31 to form spiral flow guide channels 312.

By adopting the above structure, the present invention has the following advantages:

Firstly, the fuel gas enters the internal cavity of the burner 31 from the flow channel head end 33 of the internal cavity of the burner 31, and flows to the flow channel tail end 34 of the internal cavity of the burner 31 under the guide of a one-way extending flow channel structure of the internal cavity of the burner 31. In addition, the fuel gas flowing through all the positions of the internal cavity of the burner 31 is jetted out via the corresponding flow guide channels 312 and burnt to generate flames.

Secondly, since the flow channel head end 33 of the internal cavity of the burner 31 and the flow channel tail end 34 of the internal cavity of the burner 31 are cut off, the fuel gas in the internal cavity of the burner 31 can only flow in a one-way manner, preventing the gas flow at the flow channel tail end 34 of the internal cavity of the burner 31 from flowing to the flow channel head end 33 of the internal cavity of the burner 31 or the gas flow at the flow channel head end 33 of the internal cavity of the burner 31 from reversely flowing into the flow channel tail end 34 of the internal cavity of the burner 31 to cause a decrease in the gas pressure at the flow channel tail end 34 of the internal cavity of the burner 31 to affect the intensity of the flames.

In addition, the fuel gas is jetted out in a spiral manner under the action of the flow guide channels 312, so that the gas jetted out of all the burning ports 311 meets in a spiral manner to generate a flame column, making it easier for the flames to converge.

In addition, since the flame-gathering cover 32 arranged also has the function of gathering the flames, the gathering effect is better. In addition, the flame-gathering cover 32 can be arranged to prevent the food and residue getting into the flame-gathering cover 32 from coming into contact with the burning ports 311, so that the food and residue are prevented from being sintered and carbonized to block the burning ports 311.

Preferably, the cross-sectional shape of the internal cavity of the burner 31 in this embodiment is gradually reduced from the flow channel head end 33 of the internal cavity of the burner 31 to the flow channel tail end 34 of the internal cavity of the burner 31.

Therefore, the internal cavity of the burner 31 is gradually reduced from the low channel head end 33 of the internal cavity of the burner 31 to the flow channel tail end 34 of the internal cavity of the burner 31, the pressure diverted by the internal cavity of the burner 31 from the flow guide channels 312 is compensated, making the pressure in the internal cavity of the burner 31 more uniform and minimizing the pressure difference between the flow channel head end 33 of the internal cavity of the burner 31 and the flow channel tail end 34 of the internal cavity of the burner 31, so that the fuel gas flowing out of all the flow guide channels 312 is kept at close pressures, and therefore, the fuel gas in all the flow guide channels 312 is jetted out at close speeds and ignited to generate more uniform flames.

Preferably, as shown in FIG. 10, an included angle γ between the axis in an extending direction of each flow guide channel 312 and the volute axis of the internal cavity of the burner 31 in this embodiment is an acute angle. Therefore, the transition of the fuel gas entering the flow guide channels 312 from the internal cavity of the burner 31 is smoother, reducing the loss of kinetic energy of the fuel gas entering the flow guide channels 312 from the internal cavity of the burner 31. Therefore, the jetted fuel gas is faster, and the intensity of flames is enhanced after the fuel gas is ignited.

Preferably, the shape of the flow guide channel 312 in this embodiment is gradually reduced from an end close to the internal cavity of the burner 31 to an end far from the internal cavity of the burner 31, so that the fuel gas from the internal cavity of the burner 31 is further pressurized in the gradually reduced flow guide channel 312 to jet out at a higher speed, improving the intensity of flames. Specifically, the overall shape of the flow guide channel 312 is trapezoidal.

Preferably, the internal cavity of the burner 31 in this embodiment has a cross-sectional shape that is gradually reduced from the lower end to the upper end thereof, to make the amount of circulating fuel gas in the internal cavity of the burner 31 larger, and has the effect of increasing the speed of the fuel gas in a constricting manner when the fuel gas upwardly enters the flow guide channels 312, to achieve better gas jetting effect.

The number of turns of the internal cavity of the burner 31 in this embodiment is one, so as to optimally adapt to the flow guide channels 312 arranged annularly. In addition, in other embodiments, the number of turns of the internal cavity of the burner 31 may be set to be less than one, so that the flow guide channels 312 can only be arranged in a part of the area, or the number of turns of the internal cavity of the burner 31 may be set to be greater than one, and adaptively, the flow guide channels 312 need to be arranged in a volute form for more than one turn as well.

In addition, the inner circumference of the burner 31 is provided with an avoidance cavity 313, and the burning ports 311 are formed by being arranging along the edge of an upper port of the avoidance cavity 313.

In addition, the burner 31 is provided with a gradually reduced upward protective section 314 located over the burning ports 311, and the upper end of the protective section 314 encloses a first flame port 315. Therefore, under the action of the protective section 314, not only can garbage falling from above into the avoidance cavity 313 be prevented from approaching the burning ports 311 and being sintered to block the burning ports 311, but also the protective section 314 has a certain ability to converge the flames due to necking in the same direction as the spiral direction of the flames.

In addition, the internal cavity of the burner 31 is provided with an inner flow channel wall 316 and an outer flow channel wall 317. The inner flow channel wall 316 is annularly arranged, the outer flow channel wall 317 is located at a periphery of the inner flow channel wall 316, and gradually approaches the inner flow channel wall 316 from the flow channel head end 33 to the flow channel tail end 34, and the flow guide channels 312 are circumferentially arranged at intervals over the inner flow channel wall 316 in a circumferential direction of the inner flow channel wall 316.

Therefore, since the outer flow channel wall 317 gradually approaches the inner flow channel wall 316, a shape, the cross-sectional area of which is gradually reduced, is formed, and since the inner flow channel wall 316 is annular, the shape of the inner flow channel wall 316 is regular, making the structure more orderly. In addition, the flow guide channels 312 are arranged adapting to the annular inner flow channel wall 316, making the overall design structure more orderly, and therefore, the flames jetted out from all the burning ports 311 are more uniform under the condition of stable pressure supply by the corresponding flow guide channels 312.

In addition, the internal cavity of the burner 31 is provided with an upper flow channel wall 318 and a flow-increasing sidewall 319. The upper flow channel wall 318 is inclined upwards from one side of the outer flow channel wall 317 to one side of the inner flow channel wall 316. The flow-increasing sidewall 319 is arranged at an end of the gas channel tail end 34, is located between the upper flow channel wall 318 and the outer flow channel wall 317, and is arranged in an outwardly arched arc shape.

Therefore, the fuel gas which transits from the internal cavity of the burner 31 into the flow guide channels 312 is continuously and more smoothly constricted before entering the flow guide channels 312, reducing the loss of kinetic energy and ultimately entering the flow guide channels 312 at a higher pressure and a higher speed. In addition, the space at the flow channel tail end 34 is enlarged by the flow-increasing sidewall 319, so that there is more fuel gas at the flow channel tail end 34 to ensure gas pressure for effectively supplying the fuel gas to the flow guide channels 312 at the flow channel tail end 34.

The grill base 12 is provided with a fixed plate 122, which is provided with a round hole. The lower end of the burner 31 is mounted on the upper side of the fixed plate 122, and the hollow inner circumference of the volute burner 31 downwardly corresponds to the round hole in the fixed plate 122.

In addition, the bottom of the burning chamber 112 is provided with a round installation port 113, an annular cover 1234 is arranged in the burning chamber 112, and is continuously arranged along the edge of the installation port 113, and the annular cover 1234 is gradually reduced from bottom to top, so that the inner diameter of an upper port of the annular cover 1234 is less than that of a lower port. In addition, the burning areas of the flame-gathering cover 32 and the burner 31 are both located in the annular cover 1234, and the upper end of the flame-gathering cover 32 passes through the upper port of the annular cover 1234 and then extends out. In addition, a spacing exists between an inner wall of the upper end of the annular cover 1234 and a peripheral wall of the flame-gathering cover 32, the peripheral wall of the flame-gathering cover 32 is provided with a plurality of air supply openings 322 to communicate the inside of the flame-gathering cover 32 with the outside, and each air supply opening 322 is located in the annular cover 1234.

Therefore, the annular cover 1234 partitions the flame-gathering cover 32 from the burning chamber 112 under the roasting area 21, so that the heat emitted by the flame-gathering cover 32 cannot be directly diffused into the burning chamber 112, but needs to upwardly flow to the heat flow channel 22 along with the high-temperature gas flow to make the high-temperature gas flow more concentrated. In addition, the annular cover 1234 is gradually reduced from bottom to top to better adapt to the shape of the flame-gathering cover 32, so that the structure is more compact. In addition, because burning in the flame-gathering cover 32 consumes oxygen and the gas pressure is decreased, the arrangement of the air supply openings 322 in the flame-gathering cover 32 allows the outside air with greater pressure to enter the inside of the flame-gathering cover 32 from the outside of the flame-gathering cover 32 to replenish oxygen, to improve the burning efficiency.

In other embodiments, the upper end of the flame-gathering cover 32 is located in the annular cover 1234.

In addition, the grill base 12 in this embodiment is also provided with a mounting frame 6 located at the lower end of the burning portion 3. A collector 7 is detachably arranged on the mounting frame 6, and is configured to collect garbage which has passed through the inner circumference of the burner 31 and dropped, so that a small amount of food and residue splashed into the flame-gathering cover 32 can be collected, and the collector 7 can be dismounted for the disposal of the collected food and residue, so as to keep sanitary during use.

Specifically, the mounting frame 6 in this embodiment includes a round retaining ring 61 and support rods 62 located at both radial sides of the retaining ring 61. Each support rod 62 includes an arc-shaped mounting section 621, lower side sections 622 symmetrically arranged at both sides of the mounting section 621 in a length direction, and support sections 623. Each mounting section 621 is fixedly arranged on the grill base 12 by welding, riveting, bolting, etc., each lower side section 622 is vertically arranged, and the upper end of each lower side section 622 is integrally formed with the corresponding mounting section 621. The retaining ring 61 is fixed near the lower end of each lower side section 622 by welding. Each support section 623 is horizontally arranged, with one end of each support section 623 being integrally formed with the lower end of the corresponding lower side section 622, and the other end of each support section 623 being located under the inner circumference of the retaining ring 61. In addition, the collector 7 includes a vessel portion 71 and a handle portion 72. A periphery of the vessel portion 71 is adapted to the retaining ring 61, and the height of the vessel portion 71 is less than a spacing between the retaining ring 61 and the mounting section 621. Therefore, when the handle portion 72 is held, the vessel portion 71 can be inserted between the two support rods 62 from above the retaining ring 61 and aligned with the retaining ring 61, and then faces downwards, so that the vessel portion 71 enters the retaining ring 61 and is supported by all the support sections 623 for mounting. In addition, if the collector 7 needs to be removed, the collector 7 can be reversely taken out by holding the handle portion 72.

In addition, the grill base 12 in this embodiment is provided with a water basin 1231 at the bottom of the burning chamber 112. The water basin 1231 is opposite to the roasting area 21, so that water can be stored in the water basin 1231, and therefore, food and residue dropping from the roasting area 21 will drop into the water basin 1231. The food and residue not only can be collected, but also can be prevented from being burnt to generate smoke or sticking to the grill base 12, so that the grill for closed lid braising and roasting is safer to use and can be more conveniently cleaned.

More specifically, the grill base 12 is provided with a detachable roasting basin 123, and the annular cover 1234 is a part of the structure of the roasting basin 123. The roasting basin 123 further includes an annular outer wall 1232 and a bottom wall 1233, where the outer wall 1232 is inclined inwards and downwards in a radial direction, and the outer circumference of the bottom wall 1233 is connected with the bottom of the outer wall 1232 and the inner circumference of the bottom wall 1233 is connected to the bottom of the annular cover 1234, so as to form the trapezoidal water basin 1231.

In addition, the grill body 1 further includes a cart body 14. The grill base 12 is placed on the cart body 14, and a gas tank 141 is arranged in the cart body 14 to supply fuel gas to the burner 31.

In addition, the cart body 14 is square, and the four corners of the lower end of the cart body 14 are provided with rollers 142, so that the cart body 14 can move by rolling.

Preferably, the heat flow channel 22 is arranged at the circle center of the roasting net 2. The heat-gathering recess 411 is shaped like a truncated cone. The diameter of the roasting net 2 is d, and a spacing between the flow guide 4 and the roasting net 2 is x (0.1d≤s3≤0.3d, and 0.2d≤x≤0.4d; and specifically, s3=0.18d and x=0.28d in this embodiment).

Therefore, since the round shape is adopted as a main shape for structural arrangement, the temperature in the circumferential direction of the roasting area 21 is more uniform. Moreover, by controlling a ratio of the diameter of the roasting net 2, the spacing between the flow guide 4 and the roasting net 2 and the diameter of the heat-gathering opening 4111, the internal temperature under a lid closing state is more uniform.

### Embodiment 2

The main structure of a grill for closed lid braising and roasting is the same as that in Embodiment 1, except that the upper end of a burning chamber 112 is provided with a square opening, and correspondingly, a roasting net 2 and a grill lid 13 are square.

### Embodiment 3

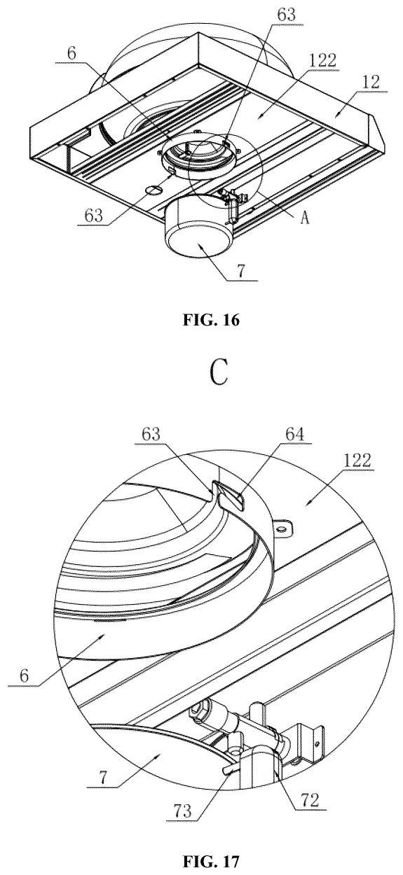

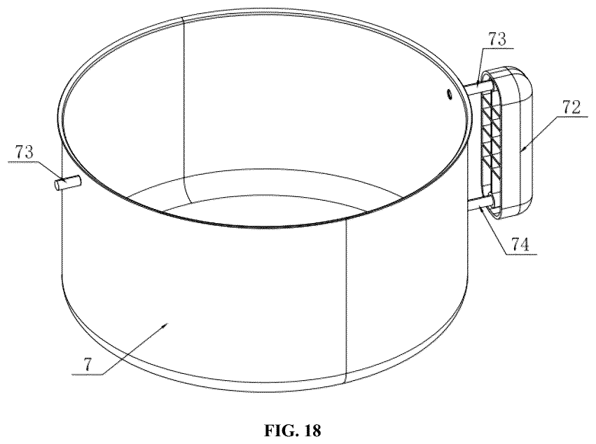

As shown in FIGS. 16 to 18, the main structure of a grill for closed lid braising and roasting is the same as that in Embodiment 1, except that a mounting frame 6 is annularly arranged, and the top of the mounting frame 6 is fixed on the bottom of a grill base 12 by welding, riveting, bolting, etc., while the bottom of the mounting frame 6 is provided with a plurality of upwardly extending access notches 63 in a circumferential direction; the upper part of each access notch 63 is provided with a retaining notch 64 extending in a circumferential direction of the mounting frame 6; the lower side of each retaining notch 64 is inclined downwards in a direction away from the corresponding access notch 63; correspondingly, a periphery of a collector 7 is provided with horizontally extending assembling rods 73 corresponding to the access notches 63 respectively; and the assembling rods 73 can upwardly enter the upper ends of the access notches 63 from the lower ends of the access notches 63 and be aligned with the retaining notches 64 and then rotated to enter the retaining notches 64, so that the assembling rods 73 are stably installed at the bottoms of the retaining notches 64 and far away from the access notches 63 under the action of gravity, thus ensuring that the collector 7 is stably assembled on the grill base 12.

In addition, the collector 7 is provided with a handle portion 72. One end of one of the assembling rods 73 is connected with the collector 7, the other end of the assembling rod 73 is connected with the upper end of the handle portion 72, and a connecting rod 74 is arranged between the lower end of the handle portion 72 and the collector 7. Therefore, the handle portion 72 can be mounted under the joint action of the assembling rod 73 and the connecting rod 74.

What is claimed is:

1. A grill for closed lid braising and roasting, comprising:
a grill body, wherein a grill chamber is arranged in the grill body;
a roasting net, wherein the roasting net is arranged in the grill chamber to divide the grill chamber into a braising and roasting chamber and a burning chamber, a burning portion is arranged in the burning chamber, the roasting net is provided with a net-like roasting area and a heat flow channel running through from top to bottom, and the heat flow channel is arranged opposite to the burning portion; and
a flow guide, wherein the flow guide is arranged in the braising and roasting chamber, and comprises a heat-gathering portion and an extension portion, the extension portion surrounds a periphery of the heat-gathering portion, the heat-gathering portion is provided with a sunken heat-gathering recess, a spacing exists between the roasting net and the flow guide, the heat flow channel is arranged opposite to the heat-gathering recess, and the extension portion is arranged opposite to the roasting area, and
wherein a high-temperature gas flow generated by burning of the burning portion passes through the heat flow channel and reaches the heat-gathering recess, the heat-gathering recess guides the high-temperature gas flow to the extension portion and the roasting area, and the extension portion also guides the high-temperature gas flow to the roasting area.

2. The grill for closed lid braising and roasting according to claim 1, wherein the burning portion comprises a flame outlet, and an inner diameter of the flame outlet is s1;
an inner diameter of the heat flow channel is s2;
a low end of the heat-gathering recess is provided with a heat-gathering opening, and an inner diameter of which is s3, and
wherein s1<s2<s3.

3. The grill for closed lid braising and roasting according to claim 2, wherein the heat-gathering portion comprises a top plate and a ring-shaped first flow guide skirt, and an upper end of the first flow guide skirt is connected to an edge of the top plate; and
the first flow guide skirt is gradually enlarged from top to bottom, so that the first flow guide skirt is inclined relative to the top plate, and an included angle between the first flow guide skirt and the top plate is α, which is an obtuse angle.

4. The grill for closed lid braising and roasting according to claim 3, wherein the extension portion comprises a horizontal flow guide portion and a ring-shaped second flow guide skirt, and the second flow guide skirt is continuously arranged along an edge of the horizontal flow guide portion; the second flow guide skirt is gradually enlarged from top to bottom, so that the second flow guide skirt is inclined relative to the horizontal flow guide portion; and an included angle between the second flow guide skirt and the horizontal flow guide portion is β, which is an obtuse angle.

5. The grill for closed lid braising and roasting according to claim 4, wherein an upper wall of the flow guide is spaced from an inner circumferential wall of the braising and roasting chamber, to form a heat preservation chamber between an upper sidewall formed by jointing an upper side of the heat-gathering portion and an upper side of the extension portion and the inner circumferential wall of the braising and roasting chamber; and
a communicating chamber is arranged between a periphery of the second flow guide skirt and the inner circumferential wall of the braising and roasting chamber, and is configured to communicate the heat preservation chamber with the braising and roasting chamber.

6. The grill for closed lid braising and roasting according to claim 5, wherein a periphery of the extension portion is provided with a plurality of abutting portions in a circumferential direction, and each of the abutting portions abuts against the inner circumferential wall of the braising and roasting chamber;
each of the abutting portions comprises a first connecting portion arranged on the horizontal flow guide portion and two second connecting portions arranged on the second flow guide skirt, wherein the second connecting portions are located at both sides of the first connecting portion respectively; and
the second flow guide skirt is provided with communicating holes respectively at positions corresponding to the abutting portions, wherein each of the communicating holes is located between the two second connecting portions of each of the abutting portions respectively, and a space enclosed by an inner circumferential side of the second flow guide skirt communicates with the communicating chamber.

7. The grill for closed lid braising and roasting according to claim 1, wherein the burning portion comprises a burner and a flame-gathering cover, the flame-gathering cover is sleeved on a burning area of the burner, the burner is arranged in a volute shape, the burning area of the burner is annularly arranged along a spiral path of the burner, and a plurality of burning ports which communicate with an internal cavity of the burner to jet flames are arranged in the burning area of the burner; the plurality of burning ports are arranged in an annular array along the burning area of the burner, and are located in an inner circumference of the flame-gathering cover; the flame-gathering cover is gradually reduced from top to bottom, so that an inner diameter of an upper port of the flame-gathering cover is less than that of a lower port; and therefore, flames jetted out of the burning ports can be converged and then jetted out of the upper port of the flame-gathering cover, and a flame on the inner circumference of the flame-gathering cover and a flame at the upper port of the flame-gathering cover can burn the flame-gathering cover red.

8. The grill for closed lid braising and roasting according to claim 7, wherein a bottom of the burning chamber is provided with an installation port, an annular cover is arranged in the burning chamber, and is continuously arranged along an edge of the installation port, and the annular cover is gradually reduced from bottom to top, so that an inner diameter of an upper port of the annular cover is less than that of a lower port;
at least a part of the flame-gathering cover and at least a part of the burning area of the burner are both located in the annular cover, and after running through the upper port of the annular cover, the upper end of the flame-gathering cover extends out or is located in the annular cover; and
a plurality of air supply openings are arranged on an circumferential wall of the flame-gathering cover, so that the inside of the flame-gathering cover communicates with the outside, and at least a part of the air supply openings are located in the annular cover.

9. The grill for closed lid braising and roasting according to claim 7, wherein a flow channel head end of the internal cavity of the burner and a flow channel tail end of the internal cavity of the burner are cut off;
a flow guide channel is arranged between each of the burning ports and the internal cavity of the burner, and is inclined upwards and inwards in a volute extending direction of the internal cavity of the burner;
a cross-sectional shape of the internal cavity of the burner from the flow channel head end of the internal cavity of the burner to a flow channel tail end of the internal cavity of the burner is gradually reduced;
an included angle between an axis in an extending direction of each of the flow guide channels and a volute axis of the internal cavity of the burner is Y, which is an acute angle;
a shape of the flow guide channel is gradually reduced from an end close to the internal cavity of the burner to an end far from the internal cavity of the burner;
the cross-sectional shape of the internal cavity of the burner is gradually reduced from a lower end to an upper end thereof;
the inner circumference of the burner is provided with an avoidance cavity, and the burning ports are formed by being arranged along an edge of an upper port of the avoidance cavity;
the burner is provided with a gradually reduced upward protective section located over the burning ports, wherein an upper end of the protective section circumferentially encloses a first flame port;
the internal cavity of the burner is provided with an inner flow channel wall and an outer flow channel wall, wherein the inner flow channel wall is annularly arranged, the outer flow channel wall is located on a periphery of the inner flow channel wall, the outer flow channel wall gradually approaches the inner flow channel wall from the flow channel head end to the flow channel tail end, and the flow guide channels are arranged over the inner flow channel wall at intervals in a circumferential direction of the inner flow channel wall; and
the internal cavity of the burner is provided with an upper flow channel wall and a flow-increasing sidewall, wherein the upper flow channel wall is inclined upwards from a side of the outer flow channel wall to a side of the inner flow channel wall, and the flow-increasing sidewall is arranged at an end of the flow channel tail end, is located between the upper flow channel wall and the outer flow channel wall, and is arranged in an outwardly arched arc shape.

10. The grill for closed lid braising and roasting according to claim 1, wherein the grill body comprises a grill base and a grill lid (13), a connecting portion of the grill lid is rotatably connected to an opening edge of the grill base, the grill lid is turned to open or close the grill chamber, and the flow guide is arranged on the grill lid.
